(19) United States
(12) Patent Application Publication
(10) Pub. No.: US 2026/0317954 A1
(43) Pub. Date: Oct. 15, 2026

(54) ELECTROSTRETCHING MACHINE WITH IMPROVED MATERIAL UNIFORMITY

(71) Applicant: BIOINICIA FLUIDNATEK, S.L.U., Valencia/València (ES)

(72) Inventors: Lars MARKWORT, Valencia/València (ES); David GALÁN NEVADO, Valencia/València (ES); Alfredo GIRBÉS HEREDIA, Valencia/València (ES); John BARRIO TOALA, Valencia/València (ES)

(21) Appl. No.: 19/482,152

(22) PCT Filed: May 21, 2024
(86) PCT No.: PCT/ES2024/070303

§ 371 Date: Nov. 6, 2025

(30) Foreign Application Priority Data
May 25, 2023 (ES) P202330410

(51) Int. Cl. D01D 5/00

(52) U.S. Cl. CPC D01D 5/0069; D01D 5/003; D01D 5/0076

(57) ABSTRACT

The present invention relates to an electrostretching machine with improved material uniformity in which the geometry of the electric field generated between emitter and collector is modified, in a stable or variable manner over time, thus achieving a more uniform deposition of the fibres-particles. To do this, the machine comprises steering electrodes (6), arranged at ends of the injector (1), connected to the power module (5) that subjects the same to a potential difference, to exert a repulsive or attractive force on the fibres-particles (4), and wherein the collector (3) comprises conductive material areas (8), electrically isolated from each other, arranged on a surface of insulating material (7), to which a voltage is applied that can be continuous or alternating in amplitude and/or phase.

### OBJECT OF THE INVENTION

The object of the present invention is an electrostretching machine having improved material uniformity. In the machine, the geometry of the electric field used is modified, in a stable or variable manner over time, thus achieving a more uniform deposition of the fibres-particles. To do this, the invention proposes to act on the injectors and collectors of the electrostretching machine.

### BACKGROUND OF THE INVENTION

In electrostretching machines, the injector and the collector are separated by a certain distance and a high potential difference is established between them, normally on the order of several tens of kilovolts. This causes the appearance of an electric field between the injector and collector, with its corresponding electric field lines.

Since the voltages that are generally used to feed the injector and/or the collector are stationary, that is, they do not vary over time, the electric field generated is also stationary, which causes the electric field lines to also be stationary.

During the process of forming fibres-particles using electrostretching techniques, the same become electrically charged, so that the fibres-particles tend to follow the generated electric field lines, being deposited on the collector in the preferred places defined by the stable electric field present, creating characteristic areas with a greater concentration of material and others with less, as shown in FIG. 12.

Specifically, in the left image, FIG. 12 shows the pattern of the deposition created by an injector with four emitters on a white substrate. It can be observed therein how the fibres emitted by each of the emitters do not overlap and move away from each other due to electrical repulsion. To minimise this effect, a sweeping movement is carried out by the injector over the substrate to improve the uniformity of the deposited material, in this case on a black substrate, as can be seen in the image on the right. Said image shows that there are areas with a higher density of material (whiter areas) and others with a lower density (blacker areas, in which there is hardly any material), which causes a lack of uniformity that is evident in the image. This effect can be minimised by varying the process conditions (voltages, flows, substrate speed, scanning width and speed, etc.) and the geometric configuration of the equipment (type of needle, distance between needles, emitter-collector distance, etc.), but in no case are completely satisfactory results achieved for those applications that are very demanding with uniformity.

Additionally, due to the usual arrangement of the electrodes, both of the injector and the collector, since none of them are infinite, the electric field is deformed at the ends due to the edge effect, the fibres or particles generated in the more peripheral emitters tending to be repelled outwards, as shown in FIG. 1. This also causes the deposition profile of the fibres-particles to not be uniform, more material being deposited in the central portion, and less as we approach the edges.

### DESCRIPTION OF THE INVENTION

The electrostretching machine having improved material uniformity, object of the present invention, is focussed on modifying the geometry of the electric field generated between the injectors and the collector, in a stable or variable manner over time, thus achieving that the deposition of the fibres-particles is more uniform. To do this, the invention proposes to act on the injectors and the collector of the electrostretching machine in an independent and/or combined manner.

Traditionally, the lack of uniformity in the materials obtained through electrostretching techniques is one of its main drawbacks. With the proposed invention, it is possible to improve the uniformity of the materials obtained by means of electrostretching techniques, which is an advantage for any manufacturing process in which a high degree of uniformity is required in the materials obtained, as well as between different batches. Likewise, the increase in uniformity improves the quality of the end product, also reducing the amount of reject material.

Uniformity can be defined as the variability of a certain property of a material depending on where we measure that property. This variability can be easily quantified as the standard deviation of the measurements of that property obtained about a sufficient number of samples taken from different areas of the same material. In the case of materials and coatings generated by electrostretching, these properties can be, for example, but not only, surface density gsm (grams per square metre), porosity, thickness, filtration, apparent density (surface thickness/density), diameter and size distribution of the fibres-particles, etc.

The electrostretching machine comprises one or more injectors formed by one or more emitters each, in the form of needles or without needles, separated from each other by a certain distance. Through these emitters, a solution contained in a tank is dispensed in a dispensing region, the solution being able to be formed, for example, by a polymer and a solvent, and which exits through the emitters driven by a pump at a controlled flow rate. The injector can have a fixed position, or it can be attached to translation axes that move the same in different directions in space.

Additionally, the electrostretching machine comprises a collector, which can be a static or moving flat surface, or a cylinder capable of rotating with respect to its axial axis with adjustable speed, or a roll-to-roll system. The distance between emitter and collector is adjustable. The injector and the collector are also connected to respective high voltage sources in order to generate a potential difference between the same. The solution, which is subjected to the same voltage as the injector, exits through the emitters. The potential difference between the injector and the collector causes the formed meniscus to take on a conical geometry known as a “Taylor cone”, from the apex of which a jet of electrically charged liquid is generated. During the journey that the liquid jet makes from the emitter to the collector, the solvent in the solution evaporates, so that fibres or dry particles are deposited in the collector.

As indicated previously, one of the main problems that electrostretching machines have is the lack of uniformity in the deposition of the material. This is mainly caused by two reasons.

Firstly, the different jets of liquid that are emitted from each of the emitters have an electric charge of the same sign, so that repulsive forces appear between them that affect the distribution of the fibres-particles that are formed.

This Coulomb repulsion causes the fibres-particles of each emitter to be unable to intermix with those emitted by the surrounding emitters, creating a non-uniform pattern in the deposited material, where the fibres-particles have a greater preference for being deposited in some areas than in others, following the lines of the electric field.

Moreover, this repulsion effect causes a fibre deposition profile to be created on the collector in which more material is concentrated in the central portion, and less as we approach the edges due to the greater influence of those repulsion forces.

To eliminate or minimise both effects, in a first aspect of the invention, the electrostretching machine comprises steering electrodes, arranged at the ends of the injectors. These electrodes are connected to a third high voltage source, generating an electric charge therein of the same sign as that produced in the fibres-particles. The mission of these steering electrodes is to exert a repulsive or attractive force on the outermost fibres-particles of the injector, which in turn will be transmitted to those inside, counteracting the repulsive force itself that is generated between the fibres-particles, and, in this way, concentrating its deposition in a narrower area, thereby increasing its uniformity.

The steering electrodes may be physically attached to the injectors or separated from the same. In the second case, the electrostretching machine may additionally comprise spacers positioned between the injectors and the steering electrodes.

Furthermore, the steering electrodes can have different geometries, such as bars perpendicular to the collector, a flat surface perpendicular to the collector, a flat surface folded at least once forming an angle greater than 0° with respect to the perpendicular to the collector or a curved surface.

In addition, the third high voltage source to which they are connected can be the same as the emitter or a different one. The geometry, location and voltage of these steering electrodes must be adjusted to the solution used, the type of injector and the parameters used in each process.

In turn, the position and voltage to which these steering electrodes are subjected can be fixed or variable over time. In the event that they are variable over time, the force exerted on the fibres or particles is also variable, as is the electric field. In this way, the preferential paths that are generated in an electric field constant over time are eliminated and, therefore, the uniform distribution of the deposition of the fibres-particles is facilitated.

In the case of the collector, this is usually an electrode of fixed geometry, static or moving, to which a constant voltage is applied that does not vary with time, which causes a stationary electric field distribution to be created. Following the same reasoning set forth for the injector, the fibres-particles that are created, being electrically charged with a charge of the same sign, are deposited on the collector in a non-homogeneous manner following the preferential lines defined by the stationary electric field present.

Therefore, in a second aspect of the invention, the collector of the electrostretching machine additionally comprises a band collector electrode, which comprises a first motorised conveyor belt of insulating material and conductive material areas, electrically isolated from each other, arranged on the insulating material surface of the band collector electrode. The collector also comprises as many high voltage sources as there are conductive material areas, each of them connected to one of the conductive material areas.

Additionally, the machine comprises a dielectric or moderately conductive substrate, arranged on the band collector electrode, between the conductive material areas and the injectors, intended to receive the deposition of the fibres-particles, arranged on a second motorised conveyor belt.

The number and geometry of the conductive material areas, as well as the voltage or phase switching frequency between the different conductive areas, must be adjusted to the solution used, the type of injector(s) and the parameters used in each process.

Additionally, to improve the uniformity of the material, the electrostretching machine may comprise a displacement module connected to the band collector electrode and, if necessary, to the dielectric substrate, so that they can remain stationary or in motion, one being displaced with respect to the other.

The dielectric or moderately conductive substrate and the band collector electrode will move at the same or different speed. In this way, the geometry of the generated electric field is caused to be variable due to the movement of the band collector electrode, and with it the deposition of the fibres-particles, achieving greater homogeneity on the substrate.

In one aspect of the invention, one or more of the high voltage sources is variable voltage, and the band collector electrode travels at the same speed and in opposite directions to the dielectric substrate. In this embodiment of the invention, the electrostretching machine comprises a control module, connected to the high voltage sources connected to the conductive material areas, configured so that one or more high voltage sources apply a time-varying, different and time-offset voltage to each conductive material area.

In another embodiment of the invention, the conductive material areas arranged on the band collector electrode of insulating material are arranged alternately following a certain geometric pattern. As previously stated, the dielectric or moderately conductive substrate is located on the band collector electrode, where the fibres-particles are deposited. In this embodiment, the mobile patterned band collector electrode is connected to a high voltage source that feeds the conductive regions continuously. During its operation, the patterned band collector electrode moves at a greater speed than that of the substrate, so that the electric field lines projected on the substrate constantly change, thereby ensuring that the deposition of the fibres-particles occurs throughout the surface of the band collector electrode.

In a variant embodiment of the prior invention, the machine additionally comprises a slotted static conductive electrode, with material-free areas by way of a grid, positioned between the band collector electrode and the substrate. The overlap of the slotted static conductive electrode and the patterned mobile band collector electrode manages to constantly modify the electric field lines that are created between the emitter and the collector, thereby ensuring that the deposition of the fibres-particles occurs on the entire surface of the collector.

In another variant embodiment of the invention, the collector additionally comprises a static electrode patterned with conductive material regions and insulating material regions, placed at the bottom of the band collector electrode, on a face opposite to the substrate. In this embodiment, the high voltage is applied to both the band collector electrode and the patterned static electrode, and the speed of the band collector electrode is equal to that of the substrate. The overlap of the moving band collector electrode with respect to the patterned static electrode manages to constantly modify the electric field lines that are created between the emitter and the collector, thereby ensuring that the deposition of the fibres-particles occurs on the entire surface of the collector.

### DESCRIPTION OF THE DRAWINGS

As a complement to the description provided herein, and for the purpose of helping to make the features of the invention more readily understandable, in accordance with a preferred practical exemplary embodiment thereof, said description is accompanied by a set of drawings constituting an integral part of the same, wherein by way of illustration and not limitation, the following has been represented:

FIG. 1 shows a state of the art electrostretching machine. At the top, a schematic representation of the emission of the electrically charged fibres-particles and the effect of the repulsive force between the same. At the bottom, a graph of the deposition profile of the fibres-particles.

FIG. 2 shows, at the top, an electrostretching machine with improved material uniformity in the emitter and steering electrodes attached thereto using electrical insulating spacers. At the bottom, it shows a comparison of the deposition profile of the fibres-particles when a continuous or variable voltage is applied to the steering electrodes over time.

FIG. 3 shows an electrostretching machine with improved material uniformity in the emitter and steering electrodes attached thereto.

FIG. 4 shows an electrostretching machine with improved material uniformity in the emitter and steering electrodes separated therefrom.

FIG. 5 shows an electrostretching machine with improved material uniformity in the emitter and flat steering electrodes.

FIG. 6 shows an electrostretching machine with improved material uniformity in the emitter and folded steering electrodes.

FIG. 7 shows an electrostretching machine with improved material uniformity in the emitter and curved steering electrodes.

FIG. 8 shows an electrostretching machine with improved material uniformity through a collector with different areas of a conductive material to which a time-varying voltage signal is applied, offset with each other.

FIG. 9 shows an electrostretching machine with improved material uniformity through a patterned collector with conductive material areas and insulating areas, in which the patterned collector is mobile and is in direct contact with an insulating substrate.

FIG. 10 shows an electrostretching machine with improved material uniformity through a patterned collector with conductive material areas and insulating areas, in which the patterned collector is mobile separated from the substrate by a grid-like electrode.

FIG. 11 shows an electrostretching machine with improved material uniformity through a patterned collector with conductive material areas and insulating areas, in which the patterned collector is static and is separated from the substrate by a conveyor belt with slots.

FIG. 12 shows the deposition of fibres in a state of the art electrostretching machine, in which characteristic areas are created with a higher concentration of material and others with less.

### PREFERRED EMBODIMENT OF THE INVENTION

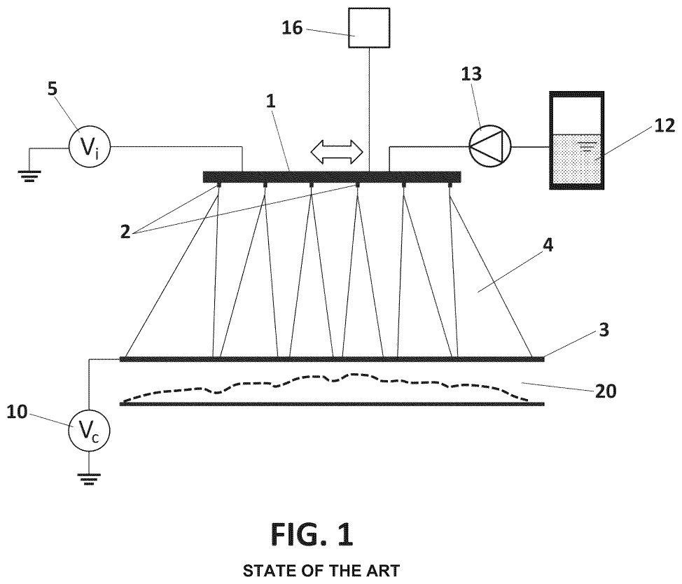

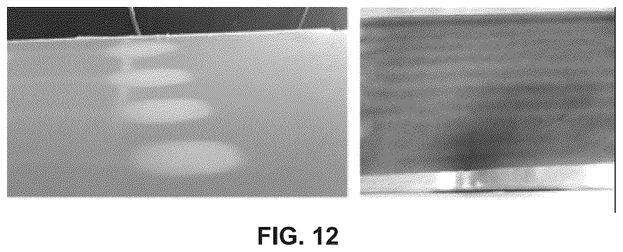

A preferred embodiment of the electrostretching machine with improved material uniformity is described below with the help of FIGS. 1 to 12.

As shown in FIG. 1, the electrostretching machines of the state of the art comprise an injector (1) which in turn comprises emitters (2), separated from each other by a certain distance. Through these emitters (2), a solution formed by a polymer and a solvent is dispensed, stored in a tank (12), driven by a pump (13) and that comes out at a flow controlled by each emitter (2), generating fibres-particles (4).

Additionally, the electrostretching machines comprise a collector (3), which can be a static or moving flat surface, or a cylinder capable of rotating with respect to its axial axis with adjustable speed, or a roll-to-roll system. The distance between injector (1) and collector (3) is adjustable.

The injector (1) and the collector (3) are intended to be connected to a first high voltage source (5) and a second high voltage source (10) respectively, which generate a potential difference between the same.

The lower area in FIG. 1 shows a fibre deposition (4) profile (20) using the state of the art electrostretching machine, with a greater concentration in the centre and a lower concentration at the edges, so that they do not have the desired uniformity.

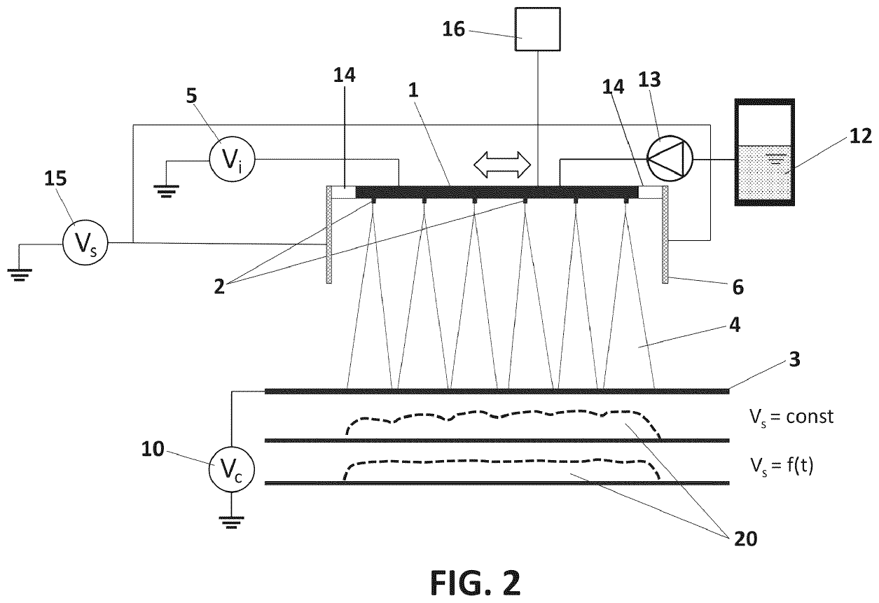

In a first aspect of the invention, which is shown in detail in FIG. 2, the electrostretching machine additionally comprises steering electrodes (6), arranged at both ends of the dispensing region, specifically at both ends of the emitter (1), and connected to a third high voltage source (15).

The steering electrodes (6) exert a repulsive or attractive force on the outermost fibres-particles (4) of the injector (1), which in turn is transmitted to those on the inside, counteracting the repulsive force generated between the fibres-particles. In this aspect of the invention, the third high voltage power supply (15) can be constant or variable voltage. If it is constant voltage, the deposition profile (20) resembles the first of those shown in the lower portion of FIG. 2, notably mitigating the edge effect and concentrating its deposition in a narrower area. If the applied voltage varies over time, the deposition profile (20) achieved is the second one shown in the lower portion of FIG. 2, achieving even greater uniformity.

Furthermore, the third high voltage power supply (15) can provide a voltage to the steering electrodes (6) equal to that of the injectors (1).

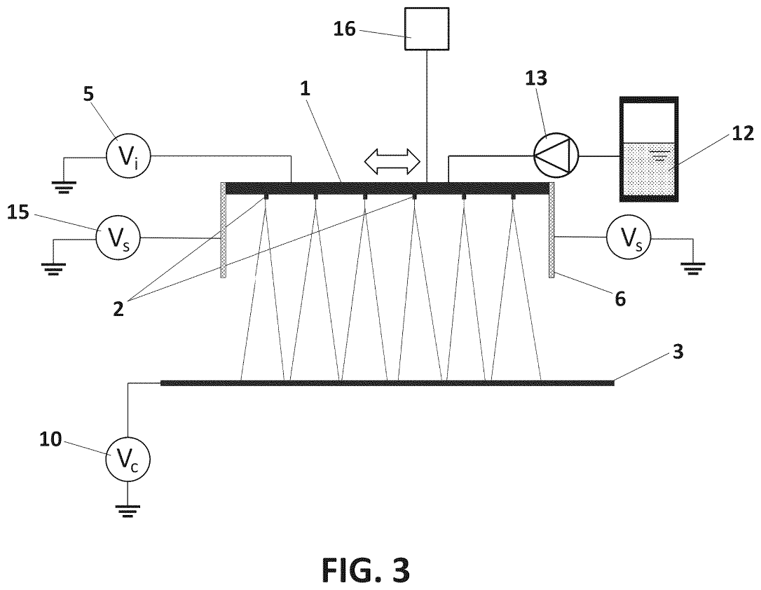

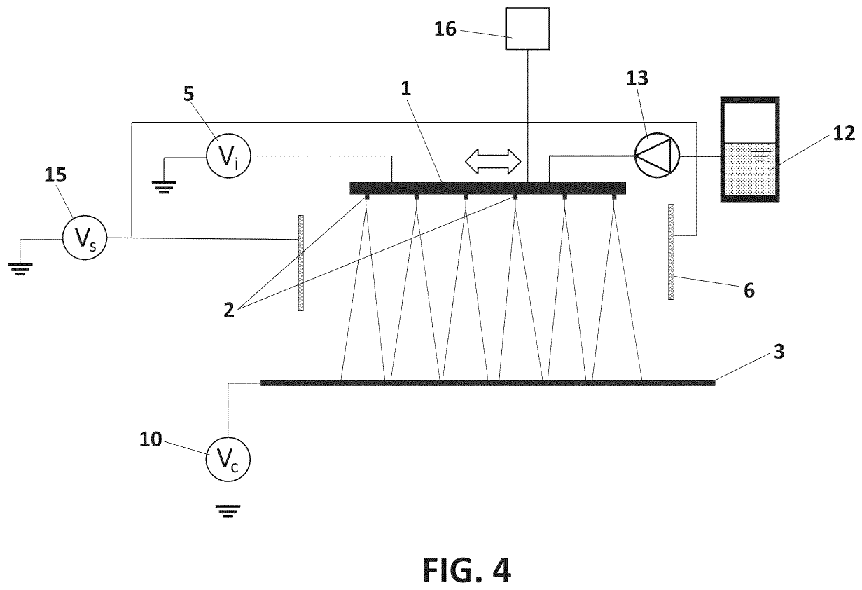

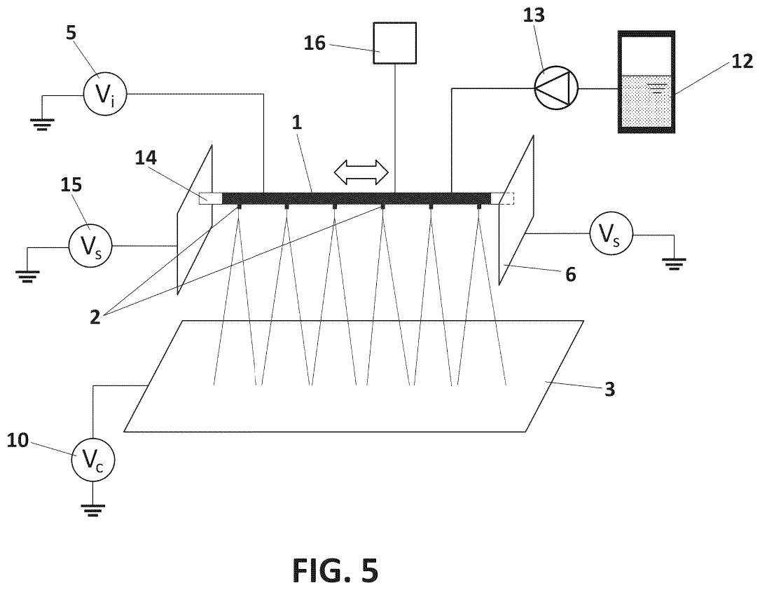

Moreover, as represented in FIG. 4, the steering electrodes (6) can be separated from the injectors (1) or attached to the injectors (1), as in FIGS. 2 and 3. In this second case, the machine may additionally comprise spacers (14) positioned between the injectors (1) and the steering electrodes (6), as in FIGS. 2 and 5.

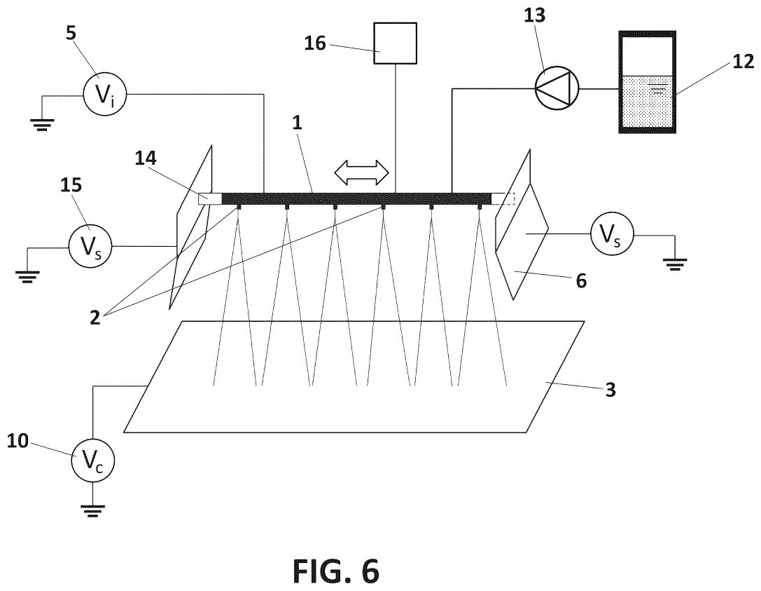

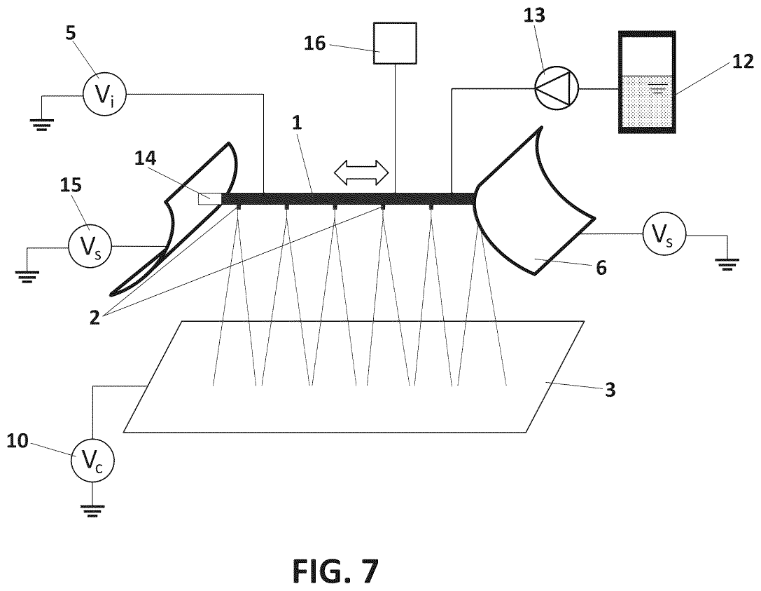

Moreover, the steering electrodes (6) can have different geometries. They can be bars perpendicular to the collector (3), as in FIG. 4, a flat surface perpendicular to the collector (3), as in FIG. 5, a flat surface folded forming at least an angle greater than 0° with respect to the perpendicular to the collector (3), as in FIG. 6, or a curved surface, as in FIG. 7.

Finally, the electrostretching machine may additionally comprise a displacement module or modules (16) connected to the injector (1), which moves it transversely with respect to the collector (3).

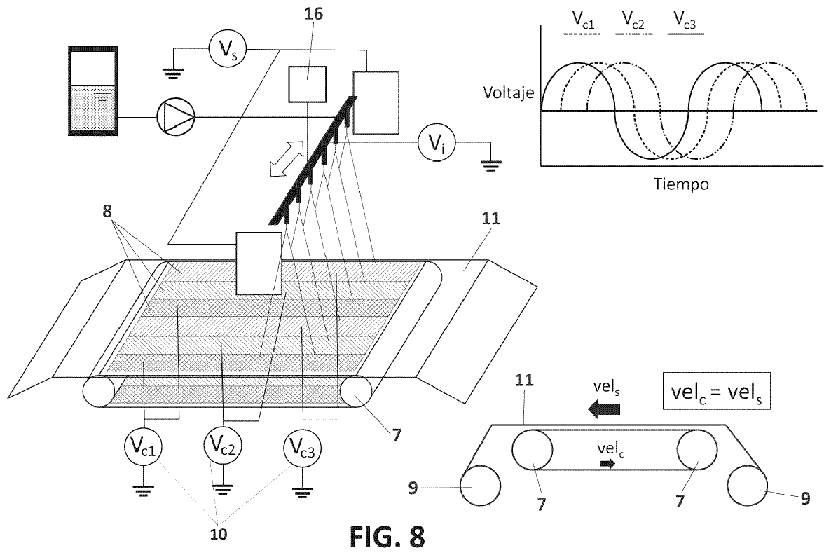

In a second aspect of the invention, shown in FIGS. 8 to 11, the collector (3) of the electrostretching machine comprises a band collector electrode (7), which comprises a first motorised conveyor belt of insulating material and conductive material areas (8), electrically insulated from each other, arranged on the insulating material surface of the band collector electrode (7). Furthermore, the collector (3) comprises as many alternating high voltage sources (10) as conductive material areas (8), each of them connected to one of the conductive material areas (8), and in which the amplitude, frequency and phase of each of them can be configured separately.

Moreover, the collector (3) comprises, as shown in said FIG. 8, a dielectric or moderately conductive substrate (11) (surface resistivity greater than 1×10⁶ Ohm), arranged on the band collector electrode (7), between the conductive material areas (8) and the emitters (2), intended to receive the deposition of the fibres-particles (4), also arranged on a second motorised conveyor belt (9).

As in the previous case and as appears, for example, in FIG. 8, the electrostretching machine additionally comprises a displacement module or modules (16) connected to the injector (1), which moves it with respect to the band collector electrode (7).

With this embodiment, it is possible to constantly modify the geometry of the electric field generated between the injector (1) and the collector (3), so that the deposition of the fibres-particles (4) occurs on the entire surface of the collector (3), and not only in the preferred areas generated by the action of a constant electric field.

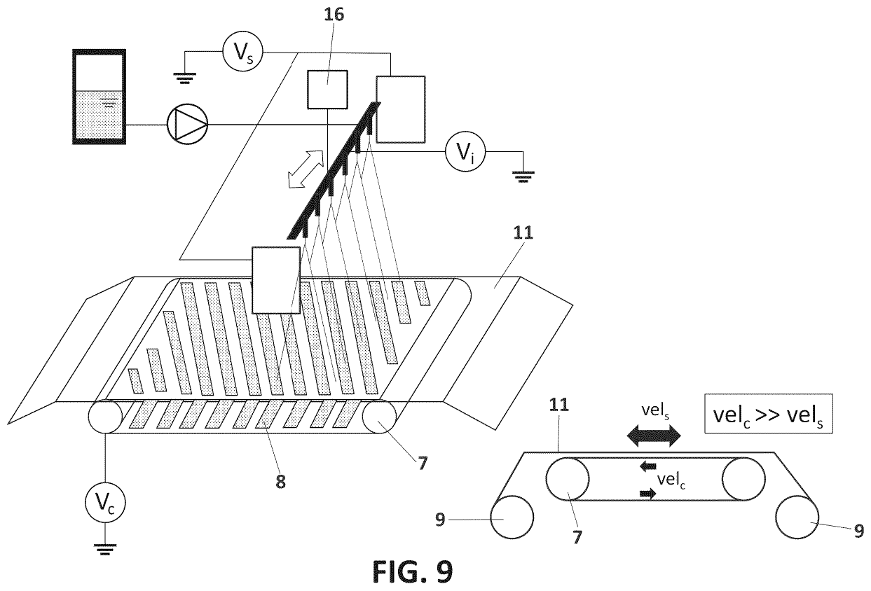

In another embodiment of the invention, represented in FIG. 9, the conductive material areas (8) arranged on the band collector electrode (7) of insulating material are arranged alternately following a certain geometric pattern. As previously stated, the dielectric or moderately conductive substrate is located on the band collector electrode (7), where the fibres-particles (4) are deposited. In this embodiment, the mobile patterned band collector electrode (7) is connected to a high voltage source that feeds the conductive areas continuously. During its operation, the patterned band collector electrode (7) moves at a speed greater than that of the substrate (11), so that the electric field lines projected on the substrate (11) constantly change, thereby achieving that the deposition of the fibres-particles (4) occurs on the entire surface of the band collector electrode (7).

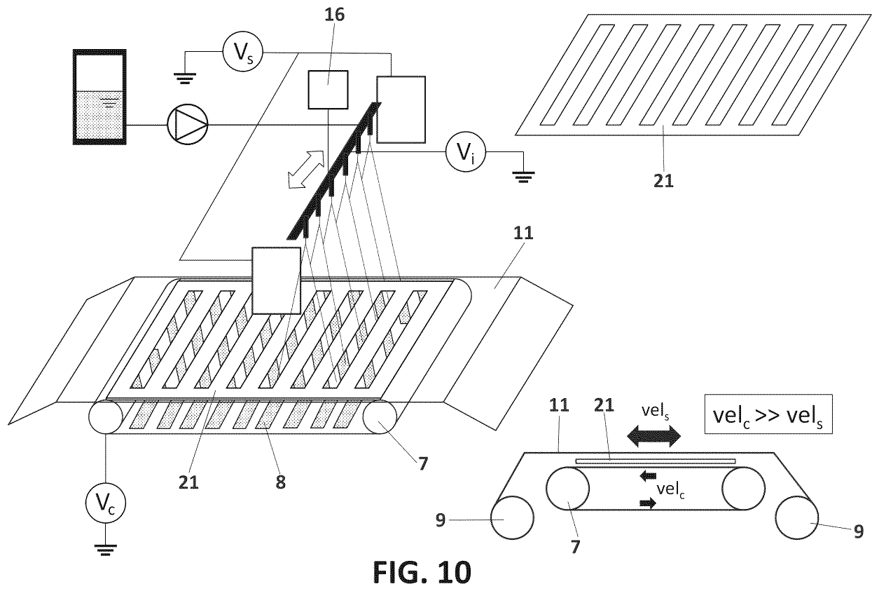

In another variant embodiment of the previous invention represented in FIG. 10, the collector (3) additionally comprises a slotted static conductive electrode (21), with material-free areas by way of a grid, positioned between the band collector electrode (7) and the substrate (11). The band collector electrode (7) moves at a greater speed than that of the substrate (11) and thus, the overlap of the slotted static conductive electrode (21) and the patterned mobile band collector electrode (7) manages to constantly modify the electric field lines that are created between the injectors (1) and collector (3), thereby ensuring that the deposition of the fibres-particles occurs on the entire surface of the collector (3).

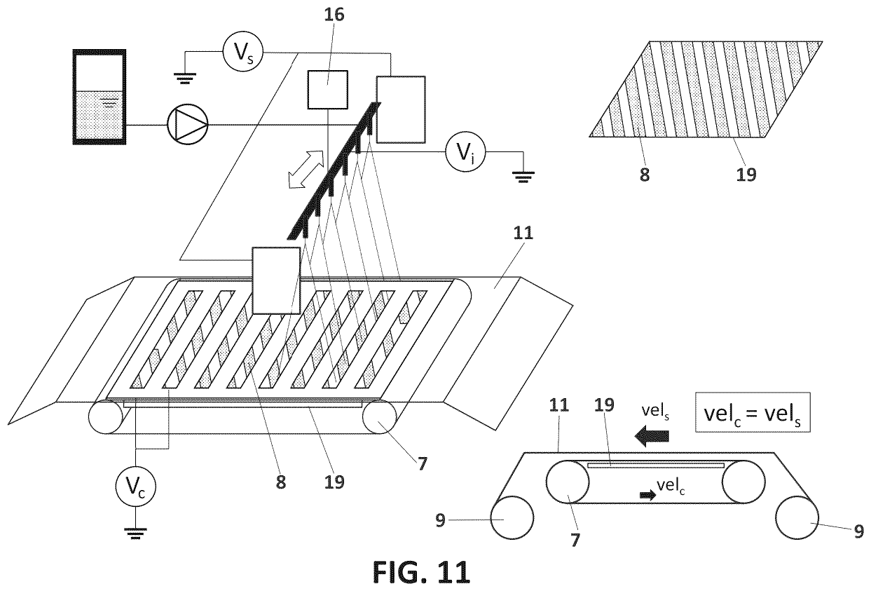

In another variant embodiment of the previous invention, represented in FIG. 11, the collector (3) additionally comprises a patterned static electrode (19) with alternating conductive material regions and insulating material regions, positioned at the bottom of the band collector electrode (7), on a face opposite to the substrate (11).

In this embodiment, the high voltage is applied to both the band collector electrode (7) and the patterned static electrode (19), and the speed of the band collector electrode (7) is equal to that of the substrate (11). The overlap of the mobile band collector electrode (7) with respect to the patterned static electrode (19) manages to constantly modify the electric field lines that are created between the injectors (1) and collector (3), thereby achieving that the deposition of the fibres-particles occurs on the entire surface of the collector (3).

In an exemplary embodiment of the first aspect of the invention, the steering electrodes (6) comprise a rectangular sheet of conductive material segmented into three portions by means of folds, oriented in the direction of the axis of the injector (1), such that the central portion is physically attached to the injector (1) or separated from the same, and the two lateral portions are suspended on both sides in the shape of a bell.

The angle of the folds will vary depending on the effect to be achieved on the electric field created between injector (1) and collector (3), varying between 90 and 180 degrees with respect to the central portion. The voltage to which the steering electrodes (6) are subjected may be the same as that of the injector (1), or different, and it may also vary over time.

In this example, the rectangular sheet that acts as steering electrodes (6) is made up of aluminium and has a thickness of between 0.1 and 50 mm, a length of between 1 and 20 cm, and a width of between 1 and 20 cm. If a time-varying voltage is used, the applied voltage signal will have an average value between 50 and −50 kV, with a signal amplitude between 0.1 and 10 kV, and a frequency between 1 and 10,000 Hz.

In an exemplary embodiment of the second aspect of the invention, the collector (3) has a total width of between 10 and 500 cm and comprises three conductive material areas (8), as in FIG. 8, oriented in the direction perpendicular to the emitter (1). The voltage signal applied to the three conductive material areas (8) has an average value of between 50 and −50 kV, with a signal amplitude of between 0.1 and 10 kV, the offset between conductive material areas (8) is 120 degrees and the phase switching frequency is between 1 and 10,000 Hz.

In another exemplary embodiment of the second aspect of the invention, the collector (3) has a total width of between 10 and 500 cm, and the geometry of the conductive material areas (8) corresponds to rectangles the short side of which goes from 1 to 50 cm and its long side from 1 to 50 cm, arranged on the band collector electrode (7) of insulating material. The conductive material areas (8) are subjected to voltages between 50 and −50 kV and the linear speed of the collector (3) is between 0.01 and 1000 mm/s.

1. An electrostretching machine with improved material uniformity through steering electrodes in the injector (1), which comprises one or more injectors (1) with one or more emitters (2), intended to dispense a solution that forms a cloud of fibres or particles (4) in a dispensing region; and a collector (3), in which the fibres-particles (4) are deposited; wherein the injectors (1) are intended to be connected to a first high voltage power source (5) and the collector (3) is intended to be connected to a second high voltage power source (10), both high voltage power sources (5, 10) generating a potential difference between them, the machine being characterised in that it additionally comprises
steering electrodes (6), arranged at ends of the dispensing region, between the emitters (2) and the collector (3), and
a third high voltage power source (15), connected to the steering electrodes (6) that subjects them to a voltage to exert a repulsive or attractive force on the fibres-particles (4).

2. The machine of claim 1, wherein the third high voltage power source (5) is constant voltage.

3. The machine of claim 1, wherein the third high voltage power supply (5) is variable voltage.

4. The machine of claim 1, wherein the third high voltage power source (5) provides a voltage to the steering electrodes (6) equal to that of the injectors (1).

5. The machine of claim 1, wherein the third high voltage power source (5) provides a voltage to the steering electrodes (6) different from that of the injector (1) and the collector (3).

6. The machine of claim 1, wherein the steering electrodes (6) are separated from the injectors (1).

7. The machine of claim 1, wherein the steering electrodes (6) are attached to the injectors (1).

8. The machine of claim 7, which additionally comprises spacers (14) positioned between the injectors (1) and the steering electrodes (6).

9. The machine of claim 1, wherein the steering electrodes (6) are bars perpendicular to the collector (3).

10. The machine of claim 1, wherein the steering electrodes (6) are a flat surface perpendicular to the collector (3).

11. The machine of claim 1, wherein the steering electrodes (6) are a flat surface folded at least once forming an angle greater than 0° with respect to the perpendicular to the collector (3).

12. The machine of claim 1, wherein the steering electrodes (6) are a curved surface.

13. The machine of claim 1, which additionally comprises a displacement module (16) connected to the injector (1), which moves the same transversely with respect to the collector (3).

14. An electrostretching machine with improved material uniformity through a patterned collector (3), which comprises one or several injectors (1) which in turn comprise one or more emitters (2), intended to dispense a solution that forms a cloud of fibres or particles (4), and a collector (3), in which the fibres-particles (4) are deposited, wherein the injectors (1) are intended to be connected to a first high voltage power source (5) and the collector (3) is intended to be connected to a second high voltage power source (10), both voltage sources generating a potential difference between them, the machine being characterised in that the collector (3) comprises:
a band collector electrode (7), which comprises a first motorised conveyor belt of insulating material,
conductive material areas (8), electrically isolated from each other, arranged on the surface of insulating material of the band collector electrode (7), between the same and the injectors (1),
as many high voltage sources (10) as there are conductive material areas (8), each of them connected to one of the conductive material areas (8),
a dielectric (11) or moderately conductive substrate, arranged on the band collector electrode (7), between the conductive material areas (8) and the injectors (1), intended to receive the deposition of the fibres-particles (4), arranged on a second motorised conveyor belt (9), and
a displacement module (16) connected to the injector (1) and to the band collector electrode (7) and the dielectric substrate (11), moving the same with respect to the injector (1).

15. The machine of claim 14, wherein at least one of the high voltage sources (10) is variable voltage and where the collector (3) additionally comprises a control module, connected to the high voltage sources (10) configured so that one or more high voltage sources (10) apply a different, time-offset, time-varying voltage to each conductive material area (8),

16. The machine of claim 14, wherein the conductive material areas (8) arranged on the band collector electrode (7) of insulating material are arranged alternately following a geometric pattern, the high voltage sources being (10) continuous feed sources and wherein the patterned band collector (7) moves at a speed greater than that of the substrate (11).

17. The machine of claim 16, wherein the collector (3) additionally comprises a slotted static conductive electrode (21), with material-free areas by way of a grid, positioned between the band collector electrode (7) and the substrate (11) and wherein the patterned band collector (7) moves at a speed greater than that of the substrate (11).

18. The machine of claim 14, wherein the collector (3) additionally comprises a patterned static electrode (19) with alternating conductive material regions and insulating material regions, positioned at the bottom of the band collector electrode (7), on a face opposite to the substrate (11) and wherein the patterned band collector (7) moves at a speed equal to that of the substrate (11).
